(19) United States
(12) Patent Application Publication
(10) Pub. No.: US 2012/0258192 A1
(43) Pub. Date: Oct. 11, 2012

(54) Hot Runner for Multi-Cavity Injection Mold

(76) Inventor: Rui Novo, Toronto (CA)

(21) Appl. No.: 13/049,978

(22) Filed: Mar. 17, 2011

Related U.S. Application Data
(60) Provisional application No. 61/315,675, filed on Mar. 19, 2010.

(51) Int. Cl. B29C 45/73

(52) U.S. Cl. 425/547

(57) ABSTRACT

The present invention is a hot runner which is easier and less expensive to manufacture and which has increased capacity. The hot runner is particularly well suited for use with multi-cavity molds. The improved hot runner includes a substantially flat main body having a main melt inlet formed in a center of the main body and a plurality of drops formed in the main body. A plurality of linear distribution channels is formed in the main body with each linear distribution channel intersecting a plurality of drops. The hot runner further includes a plurality of melt channels formed in the main body and communicating with the main melt inlet and the linear distribution channels.

### CROSS REFERENCE TO RELATED APPLICATION

This application claims priority from U.S. provisional application No. 61/315,675 filed Mar. 19, 2010, the entirety of which is incorporated herein by reference.

### FIELD OF THE INVENTION

The invention relates generally to hot runners for use with multi-cavity injection molds.

### BACKGROUND OF THE INVENTION

Hot runners for use with multi-cavity molds for use with PET perform molds generally come in a variety of sizes depending on the number of cavities contained in the desired mold. Generally speaking, the greater the number of cavities, the larger the hot runner. Typically, the largest hot runner can accommodate 32 drops, which corresponds to a mold having 32 cavities. A 36 drop hot runner has not previously been possible because the innermost four drops could not be accessed. As a result, the largest hot runner was limited to 32 drops. A 36 drop hot runner where the inner for drops could be accessed would result in a hot runner and mold combination which was the same size but with increased capacity.

### SUMMARY OF THE INVENTION

In accordance with one aspect of the present invention, there is provided an improved hot runner for use with a multi-cavity mold, the hot runner being suitable for use with higher capacity molds. The improved hot runner includes a substantially flat main body having a main melt inlet formed in a center of the main body and a plurality of drops formed in the main body. A plurality of linear distribution channels is formed in the main body with each linear distribution channel intersecting a plurality of drops. The hot runner further includes a plurality of melt channels formed in the main body and communicating with the main melt inlet and the linear distribution channels.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a top view of a hot runner made in accordance with the present invention showing the position of the drops and melt channels.

FIG. 2 is a cross sectional view through line A-A of the hot runner shown in FIG. 1.

FIG. 3 is a plan view of the hot runner shown in FIG. 1 showing only the drops and the melt channels at different levels.

FIG. 4 is a cross sectional view of a portion of the hot runner shown in FIG. 1 showing a plug blocking off a distal end channel from a distribution channel.

FIG. 5 is a top view of the plug shown in FIG. 4.

FIG. 6 is a cross sectional view of the bridge manifold portion of the hot runner made in accordance with the present invention.

FIG. 7 is a top view of the bridge manifold shown in FIG. 6.

FIG. 8 is a cross sectional view of a hot runner made in accordance with the invention showing a drop and illustrating the relationship between a valve bushing and a melt distribution channel.

In the drawings like characters of reference indicate corresponding parts in the different figures.

### DETAILED DESCRIPTION OF THE INVENTION

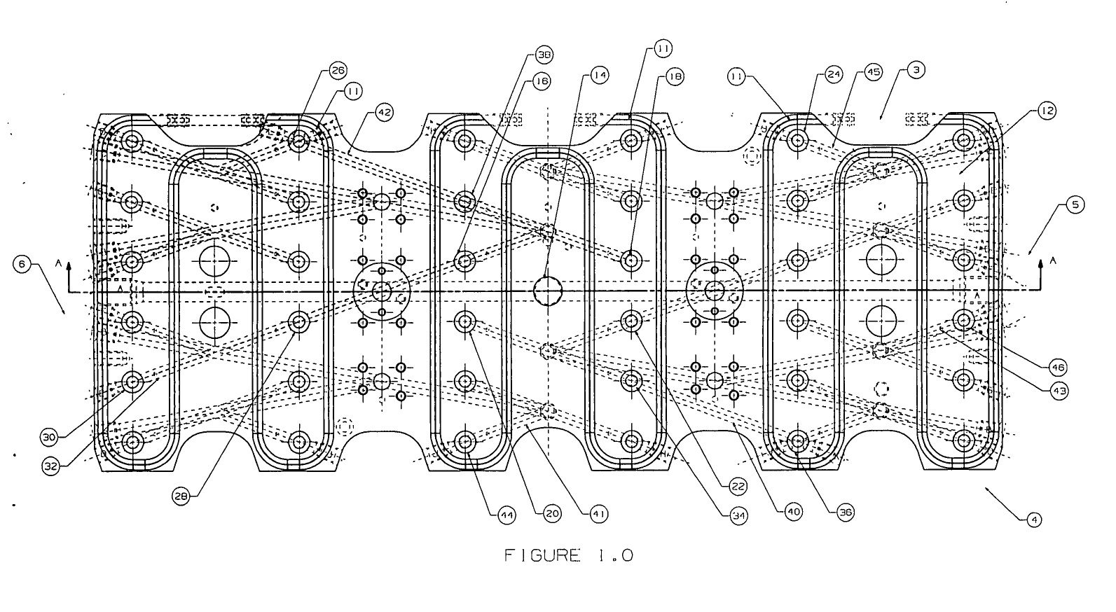

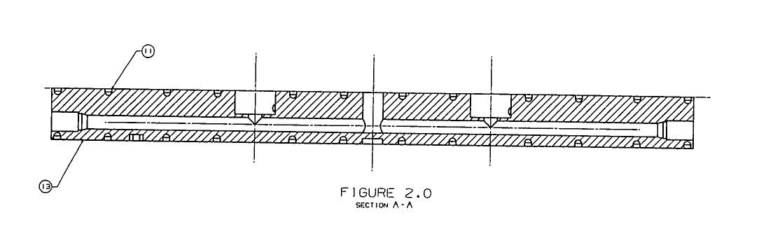

Referring firstly to FIGS. 1 and 2, a hot runner made in accordance with the present invention includes a main body 12 usually made of tool steel. Main body 12 has opposite top and bottom sides 11 and 13, opposite ends 5 and 6 and opposite sides 3 and 4. A plurality of drops (for example drops 26, 16 and 18) are formed in main body 12. In operation, these drops are supplied with melt (not shown) from main melt inlet 14 via a plurality of channels and passages which are formed in main body 12. These channels and passages are formed by drilling into the main body to leave a hollow tunnel or passage. Long drills, referred to as gun drills, are generally used to perform the task of forming the channels and passages. Distribution channels for distributing melt to the drops are preferably all formed on the same level in the main body. There are preferably two types of distribution channels, namely short distribution channels, such as channels 45 and 41 which intersect only a single drop, and long distribution channels, such as channels 32, 42, 43, and 40 that intersect a plurality of drops. Preferably, a majority of the distribution channels intersect a plurality of drops. In the case of channel 32, drops 30, 28 and 16 all intersect the channel. In the case of channel 40, drops 36, 34 and 20 are intersected by the channel. It should be pointed out that drops 16 and 20 (together with drops 18 and 22) are the closest to the center of the hot runner and nearest main melt inlet 14. Traditionally, drops are not formed in a hot runner so close to the center because a discrete channel could not be formed in the main body of the hot runner to reach the innermost drops. The present invention overcomes this drawback in the prior art by having the distribution channel intersect more than one drop. The hot runner will also include heating elements 11 which are used to keep the hot runner at an elevated temperature when the hot runner is in use.

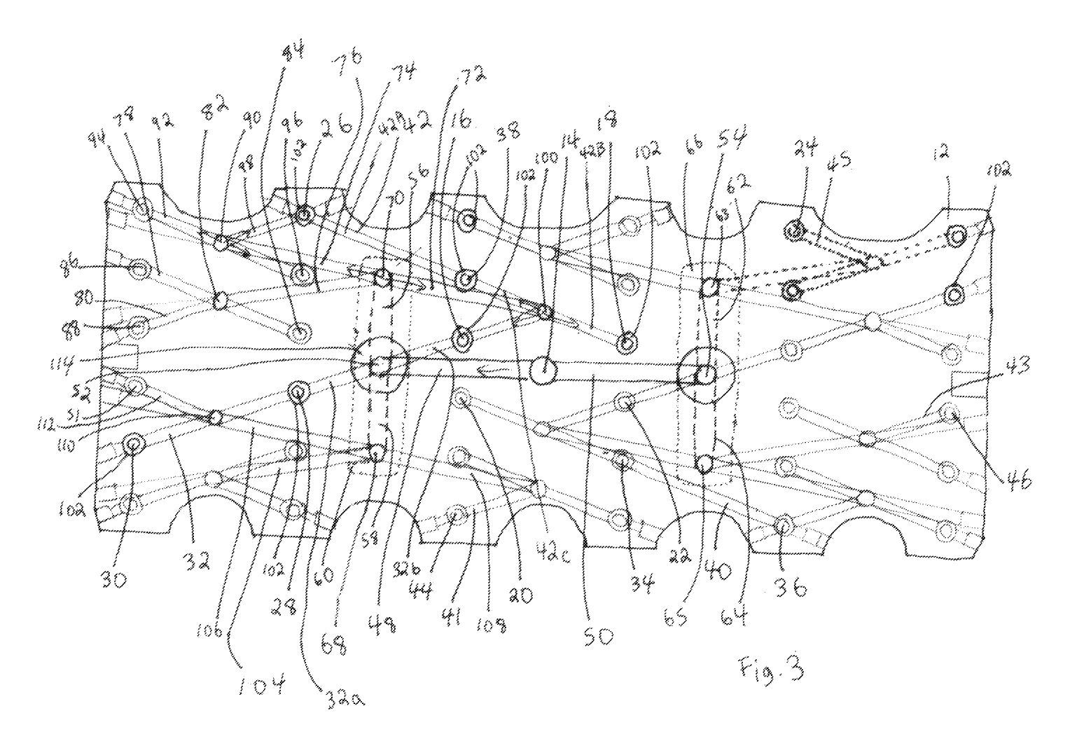

Referring now to FIG. 3, the distribution channels are supplied with melt from main melt inlet 14 (during operation) by a plurality of primary, secondary and ternary melt channels and by a plurality of passages. The various melt channels, namely the distribution channels, and the primary, secondary and ternary melt channels are all parallel to one another and extend through the main body of the hot runner substantially parallel to one another. The various melt channels, while parallel to one another, are on different planes. The passages, on the other hand, are generally perpendicular to the channels and extend through different planes in the hot runner. The passages are generally parallel to main melt inlet 14. A representative sampling of these melt channels and passages will be discussed since the total number of passages and channels will vary depending on the number of drops.

A first pair of primary melt channels 48 and 50 radiate away from main melt inlet 14 in opposite directions. Melt channels 48 and 50 extend perpendicularly away from main melt inlet 14 and communicate with distal end passages 52 and 54, respectively, at the distal ends of channels 48 and 50. A pair of secondary melt channels 56 and 48 radiate away from distal end passage 52 in opposite directions. Secondary melt channels 56 and 48 are formed in a bridge manifold 60 mounted onto main body 12. Secondary melt channel 56 terminates at melt passage 70 which extends perpendicularly to secondary channel 56. Secondary melt channel 58 terminates at melt passage 68 which extends perpendicularly to secondary channel 58. Likewise, Secondary melt channels 62 and 64 radiate away from passage 54 in opposite directions. Again, secondary channels 62 and 64 are formed in bridge manifold 66 mounted to the main body. Secondary channels 62 and 64 terminate at melt passages 63 and 65, respectively.

Melt passage 70 couples to ternary melt channels 72, 74 and 76, which in turn couple to the distribution channels. Ternary channel 74 couples to nexus passage 90 which in turn couples to distribution channel 92 and 98. Distribution channel 92 couples with drops 94 and 96; hence, in operation nexus passage 90 feeds both drops with melt. It is important to note that nexus passage 90 is positioned between drops 94 and 96; hence, the ternary melt channel couples to both drops at a point on the distribution channel between the two drops. Nexus passage 90 also feeds drop 26 via distribution channel 98. Likewise, ternary channel 76 couples to nexus passage 82 which in turn communicates with distribution channels 78 and 80. Distribution channel 78 intersects drops 86 and 84. Distribution channel 80 is short and only intersects drop 88. Ternary channel 72 couples to nexus passage 100 which in turn couples to distribution channel 42 and distribution channel 32, both of which are long channels intersecting several drops. Distribution channel 42 intersects drops 26, 38 and 18. Portion 42A of distribution channel 42 is isolated from portion 42B of distribution channel 42 by valve bushings 102. Valve bushings 102 are provided in each drop and control the flow of melt into the drop as well as preventing the leakage of melt between the drop and the valve (not shown). Nexus passage 100 is positioned between drops 18 and 38 so that the ternary channel couples to distribution channel 42 at a point between two drops.

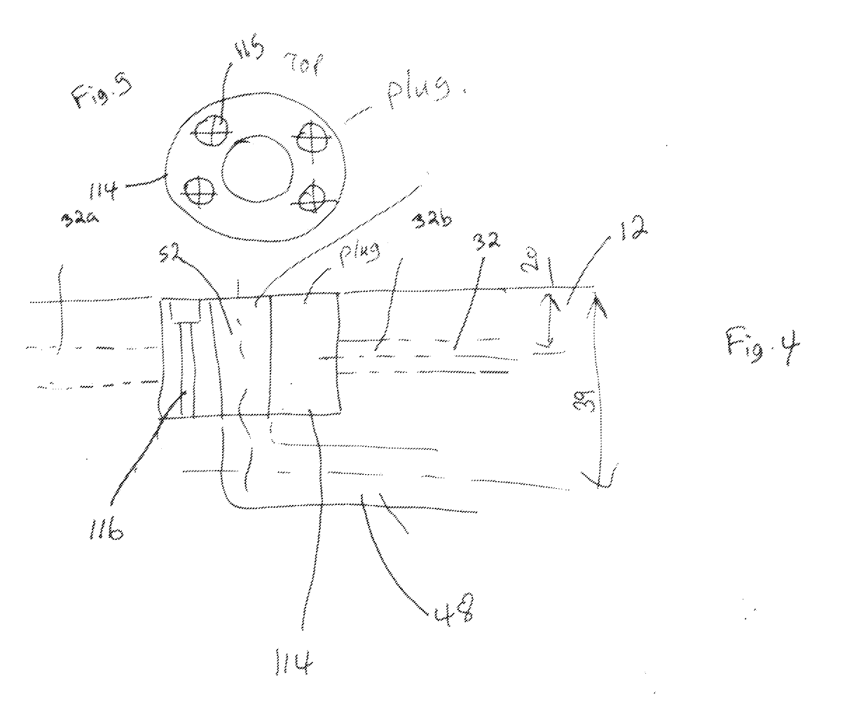

Ternary melt channels 104, 106 and 108 radiate away from melt passage 68 in different directions in a similar fashion to ternary melt channels 72, 74 and 76. Ternary melt channel 106 couples to nexus passage 110 which in turn couples to distribution channels 32 and 112. Distribution channel 112 is short and only supplies drop 51. However, distribution channel 32 is very long and intersects drops 30, 28 and 16. Nexus channel 110 is positioned between drops 30 and 28. Portion 32a of distribution channel 32 is isolated from portion 32b of channel 32 by valve bushing 102 at drop 28 and by plug 114 positioned at distal end passage 52. Plug 114 is a sleeve which is coaxially mounted within passage 52 and extends into body 12 to the level of distribution channel 32, thereby sealing off the distribution channel and dividing it between portions 32a and 32b. As better seen in FIGS. 4 and 5, plug 114 consists of a robust sleeve having apertures 115 dimensioned to receive bolts 116. When coaxially aligned with passage 52 and bolted into place, plug 114 effectively seals distribution channel 32 into separate portion 32a and 32b.

Referring now to FIG. 8, as mentioned above, the valve bushings play a key role in isolating portions of the melt channels. Each of the valve bushings are substantially identical and their relationship with the melt channel and valve is identical, so for the sake of illustration, all of the valve bushings will be discussed with reference to valve bushing 102 relating to drop 38. In the case of drop 38, a portion of melt channel 42 is divided by valve bushing 102 into portion 42a and 42c. Valve bushing 102 has neck portion 120 having groove 122 formed thereon guiding melt from melt channel portion 42c to flow to valve 126. Wall 124 is formed on neck portion 120 and, when the valve bushing is properly mounted, wall 124 effectively seals off portion 42a of melt channel 42, effectively preventing any melt from passing from portion 42c to 42a. The use of valve bushing 102 effectively divides the melt channel between two drops to create two separate melt channels from the same channel.

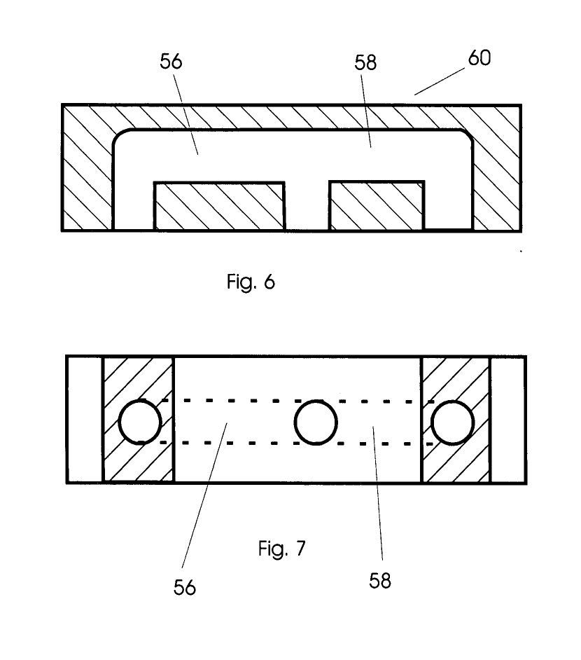

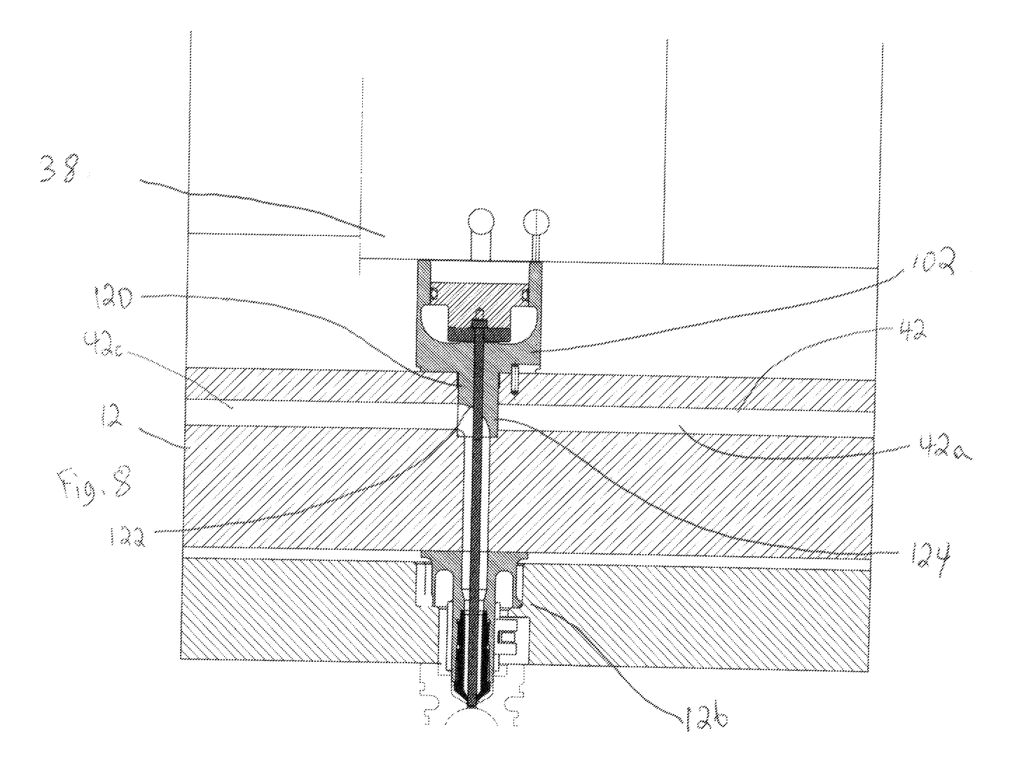

Referring now to FIGS. 6 and 7, bridge 60 consists of a body of metal which mounts to the hot runner (not shown) and which has channels 56 and 58 formed therein. Bridge 60, which is identical to bridge 66 (see FIG. 3), enables the secondary melt channels to be positioned at a different level than the distribution channels, ternary channels and primary channels.

The present invention has many advantages over the prior art. Firstly, the use of long distribution channels intersecting a plurality of different drops makes it easier and quicker to form a hot runner for use with a multi-cavity mold. Also, the use of long distribution channels intersecting several different drops allows easy access to the innermost portion of the hot runner, thereby allowing the placement of additional drops adjacent the main melt inlet while allowing for a balanced hot runner. Also, the use of valve bushings and plugs to seal off different portions of the distribution channels allows for leak free operation of the hot runner and further enables multiple drops to be supplied from different portions of the same distribution channel. The net result is a hot runner capable of increased capacity (36 drops instead of 32) but at the same time less expensive to manufacture.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A hot runner for use with a mold, the hot runner comprising:
a. A substantially flat main body having a main melt inlet formed in a center of the main body;
b. A plurality of linear distribution channels passing through the main body, the linear distribution channels intersecting a plurality of drops formed in the main body;
c. A plurality of melt channels formed in the main body and communicating with the main melt inlet and the linear distribution channels.

2. The hot runner of claim 1 wherein the drops are each sealed by a valve bushing, the melt channels coupling to the linear distribution channels between drops.

3. The hot runner of claim 1 wherein the melt channels comprise a first pair of primary melt channels formed in the main body and radiating away from the main melt inlet in opposite directions, the primary melt channels each having a distal end communicating with a distal end channel formed in the main body, a pair of secondary melt channels radiating away from each distal end channel in opposite directions, each secondary melt channel being coupled to a melt passage formed in the main body, a plurality of ternary melt channels formed in the main body and radiating away from each melt passage, each ternary melt channel communicating with a linear distribution channel.

4. The hot runner of claim 3 wherein the drops are each sealed by a valve bushing, the ternary melt channels coupling with the linear distribution channels at a point on the distribution channels between drops.

5. The hot runner of claim 4 wherein each of the distal end channels intersects one of the linear distribution channels, the distal end channel including a seal for sealing it off from the linear distribution channel.

6. The hot runner of claim 1 wherein the linear distribution channels are all formed by drilling into the main body at a first level, each of the drops extending into the first level to intersect with the linear distribution channels.

7. The hot runner of claim 5 wherein the wherein the melt channels comprise a first pair of primary melt channels formed in the main body at a second level, the primary melt channels radiating perpendicularly away from the main melt inlet in opposite directions, the primary melt channels each having a distal end communicating with a distal end channel formed in the main body perpendicular to the primary melt channels, a pair of secondary melt channels radiating away from each distal end channel in opposite directions, each secondary melt channel being coupled to a melt passage formed in the main body, a plurality of ternary melt channels formed in the main body at a third level and radiating away from each melt passage, each ternary melt channel communicating with one of the linear distribution channel by a connector passage extending into the first level and intersecting the linear distribution channel.

8. The hot runner of claim 7 wherein the drops are each sealed by a valve bushing, the ternary melt channels coupling with the linear distribution channels at a point on the distribution channels between drops.
